(19) United States
(12) Patent Application Publication
(10) Pub. No.: US 2026/0307349 A1
(43) Pub. Date: Oct. 8, 2026

(54) SLEWING DRIVE FOR A LOADING AND/OR UNLOADING APPARATUS, LOADING AND/OR UNLOADING APPARATUS WITH A SLEWING DRIVE, TIRE-HEATING PRESS AND METHOD FOR HANDLING TIRES

(71) Applicant: HARBURG-FREUDENBERGER MASCHINENBAU GMBH, Hamburg (DE)

(72) Inventor: Maximilian BEVERBURG, Hamburg (DE)

(21) Appl. No.: 19/482,338

(22) PCT Filed: Mar. 25, 2024
(86) PCT No.: PCT/DE2024/100254

§ 371 Date: Nov. 7, 2025

(30) Foreign Application Priority Data
May 8, 2023 (DE) 10 2023 111 982.6

(51) Int. Cl. B29D 30/00; F15B 15/06

(52) U.S. Cl. CPC B29D 30/0016; F15B 15/06; B29D 2030/0022; B65G 2201/0273

(57) ABSTRACT

A slewing drive for a loading and/or unloading device, a loading and/or unloading device with a slewing drive, a tire heating press, and a method for handling tires. A linear drive movement is converted into a rotary movement, enabling precise and smooth swivel movements. The linear axis of movement of the linear drive is parallel or identical to the axis of rotation of the slewing drive.

The invention relates to a slewing drive for a loading and/or unloading device.

In addition, the invention relates to a loading and/or unloading device with a slewing drive.

Furthermore, the invention relates to a tire heating press comprising at least one loading and/or unloading device with a slewing drive.

The invention also relates to a method for handling tires using a loading and/or unloading device.

The automated loading and unloading of machines, such as tire heating presses, is already carried out with the aid of loading and/or unloading devices. Particularly in the case of machines that open up the space for the object to be loaded into or unloaded from the machine between machine elements arranged vertically one above the other, it is often necessary for the loading and/or unloading device to swing sideways into this space in order to deposit or pick up the object.

Known slewing drives for loading and/or unloading devices feature horizontally arranged actuators, usually implemented by hydraulic cylinders, which move the loading and/or unloading device by linear extension or retraction around a vertically aligned swivel axis, thereby allowing it to swing in or out for loading or unloading a machine.

In addition to the high space requirements of this type of drive, they require the additional use of shock absorbers for smooth operation.

One object of the invention is to provide a slewing drive for a loading and/or unloading device that at least partially remedies the aforementioned disadvantages of known slewing drives.

This object is achieved by a slewing drive according to patent claim 1.

Further objectives of the invention are to create an improved loading and/or unloading device with a slewing drive and an improved tire heating press.

These objects are achieved by a loading and/or unloading device with a slewing drive according to patent claim 13 and a tire heating press according to patent claim 14.

A further object of the invention is to provide an improved method for handling tires.

This object is achieved by a method for handling tires according to patent claim 15.

In the dependent patent claims advantageous further developments of the invention are claimed.

The features disclosed below for a slewing drive for a loading and/or unloading device, a loading and/or unloading device with a slewing drive, a tire heating press, and a method for handling tires are part of the invention in all practicable combinations.

A slewing drive for a loading and/or unloading device according to the invention has at least one linear drive, at least one converter for converting the linear movement of the linear drive into a rotary movement, and at least one rotatable axis.

With the aid of the linear drive, a drive element can be moved back and forth on a linear axis of movement.

In preferred embodiments of the invention, the linear drive of the slewing drive is arranged such that the linear axis of movement of the linear drive and the axis of rotation of the slewing drive are approximately parallel or identical.

In advantageous embodiments of the invention, the linear drive of the slewing drive is arranged in such a way that the linear axis of movement of the linear drive is approximately vertically aligned. The corresponding arrangement of the linear drive enables a particularly space-saving design of the slewing drive in terms of the area required in the top view.

In preferred embodiments of the invention, the converter for converting the linear motion of the linear drive into a rotary motion has at least one guide and at least one sliding element guided in the guide.

The guide is designed to accommodate the sliding element and, in embodiments of the invention, is shaped in at least some areas in a spiral or helical manner.

In embodiments of the invention, the guide is designed as a groove or slot in a guide body.

In embodiments of the invention, the guide body is cylindrical or tubular.

In embodiments of the invention, the sliding element is designed as a pin, for example with a cylindrical body. In embodiments of the invention, the sliding element is designed as a roller pin and/or provided with a mushroom head.

In various embodiments of the invention, one of the elements, namely the guide or guide body or sliding element, is fixedly connected to the drive element of the linear drive at least in the direction of the linear axis of movement. The other element is mounted so that it can rotate relative to the element connected to the linear drive in such a way that it can be set in rotational motion about the axis of rotation of the slewing drive by the linear movement of the drive element of the linear drive and by the guide of the sliding element in the guide.

In preferred embodiments of the invention, the slewing drive has at least one pivot bearing, for example designed as a roller bearing, for the rotatable mounting of the respective rotatable element.

Furthermore, embodiments of the invention are conceivable in which the drive element of the linear drive is rotatable and/or has a rotatable area.

In embodiments of the invention, the rotatable element is fixedly connected to a rotatable axle which serves to connect the slewing drive to the assembly of a loading and/or unloading device to be swiveled.

The guide in the guide body has a first and a second end and runs in the direction of the axis of rotation of the slewing drive from the first end to the second end in or on the guide body.

In a sectional plane perpendicular to the axis of rotation, the angle between the first and second ends of the guide defines the maximum angle of rotation of the slewing drive.

With constant/uniform movement of the drive element of the linear drive, the change in angle defined by the guide as a function of the distance traveled by the drive element defines the rotational speed of the slewing drive.

Areas with a small change in angle as a function of the distance traveled can thus be used to incorporate slow elements into the rotational movement.

In preferred embodiments of the invention, the guide has a linear section or a section with a small change in angle as a function of the distance traveled in at least one of the end sections. This allows a movement profile to be achieved that eliminates the need for shock absorbers.

For example, motion profiles with two or more stopping points can be achieved, in which the guide is linear in the direction of the axis of rotation.

When the rotational movement is represented in a diagram in which the angle of rotation Φ of the slewing drive is plotted as a function of the position X of the sliding element in the longitudinal direction of the guide or the straight guide, at least four regions with respective associated pitches are realized in preferred embodiments of the invention.

In one embodiment of the invention, there are two end regions in which the slope is equal to 0, so that no rotation of the slewing drive occurs in these regions. With regard to the slewing drive, such regions without a slope are holding positions.

In the two other areas, the slope of the curve increases or decreases continuously. With a constant linear movement of the drive element of the linear drive, this corresponds to an increase or decrease in the rotational speed of the slewing drive. Depending on the direction of movement of the linear drive, this is reversed accordingly.

In embodiments of the invention, the rotational movement has at least one further range in which the curve has a constant slope unequal to 0. This is accompanied by a constant rotational speed of the slewing drive.

The use of transition regions in which the rotational speed is reduced evenly before stopping positions allows the slewing drive to be operated without shock absorbers because the rotational movement is stopped smoothly or gently.

In preferred embodiments of the invention, the invention has two corresponding guides realized opposite each other on or in the guide body, in each of which a sliding element is guided. This ensures lower forces acting on a single sliding element and thus reduces wear.

In preferred embodiments of the invention, the converter is at least partially arranged in a housing. In embodiments of the invention, the housing covers the guide or encloses the guide body and/or the sliding element in such a way that they are protected against the ingress of dirt and dust and/or that, for safety reasons, it is not possible for persons to reach inside.

In preferred embodiments of the invention, the slewing drive has at least one linear guide that ensures linear movement of at least one sliding element on a linear axis of movement.

In embodiments of the invention, the at least one sliding element engages both the at least one guide and the at least one straight guide. In this case, either the straight guide or the guide is fixed and immovable, so that the rotatable element provided with the other guide element can be forced to rotate.

In embodiments of the invention, the straight guide is implemented with the aid of the linear drive. For example, the shaft of the drive element is designed to be rotationally secure in the direction of the axis of rotation, corresponding to a corresponding opening in the linear drive through which the shaft of the drive element passes. In embodiments according to the invention, this can be achieved, for example, by means of an at least angular shape of the corresponding opening and the shaft cross-section.

A loading and/or unloading device according to the invention has at least one slewing drive according to the invention and a receiving device connected to the axis of the slewing drive for receiving and/or holding an object to be loaded or unloaded.

In embodiments of the invention, the receiving device is designed, for example, as a fork or similar device for receiving the object on a support surface or as a gripper.

A tire heating press according to the invention has at least one loading and/or unloading device according to the invention.

By using the loading and/or unloading device according to the invention for loading and/or unloading a tire heating press, the latter can be manufactured and maintained in a more space-saving and, due to the fact that shock absorbers are no longer required for the slewing drive, also more cost-effectively.

In preferred embodiments of a tire heating press according to the invention, the at least one loading and/or unloading device according to the invention is arranged at the head section of the tire heating press.

A method for handling tires according to the invention comprises at least the following steps:
Picking up a green tire or a vulcanized tire using a loading and/or unloading device
Swiveling into the tire heating press and depositing the green tire or
Swiveling out of the tire heating press and depositing the vulcanized tire,
   wherein a loading and/or unloading device according to the invention with a slewing drive is used.

In embodiments of the method according to the invention, the linear drive of the slewing drive is moved at a constant speed.

In embodiments of the method according to the invention, the linear movement of the drive element of the linear drive moves at least one sliding element through a guide in such a way that a rotatable element is rotated about the axis of rotation of the slewing drive.

In embodiments of the method according to the invention, a movement profile of the rotary movement is realized with at least one linear range in which no rotary movement takes place.

In embodiments of the method according to the invention, a movement profile of the rotational movement is realized with at least four regions, each with assigned rotational speeds, wherein two regions represent end regions in which no rotational movement takes place, and two regions represent transition regions in which the speed of the rotational movement is uniformly increased and/or decreased.

In embodiments of the method according to the invention, a movement profile of the rotational movement is implemented with at least five regions, each with assigned rotational speeds, wherein two regions represent end regions in which no rotational movement takes place, and two regions represent transition regions in which the speed of the rotational movement is uniformly increased and/or decreased, and one region has a constant rotational speed unequal to 0.

In embodiments of the method according to the invention for handling tires, at least one slewing drive according to the invention is used for a loading and/or unloading device and/or a tire heating press according to the invention.

The figures described below show examples of embodiments of the invention. They show:

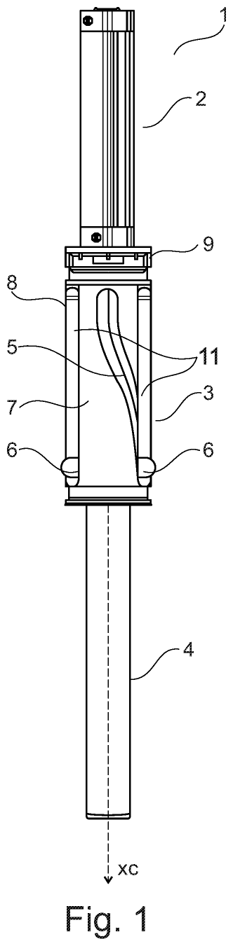

FIG. 1: A side view of an embodiment of a slewing drive according to the invention,

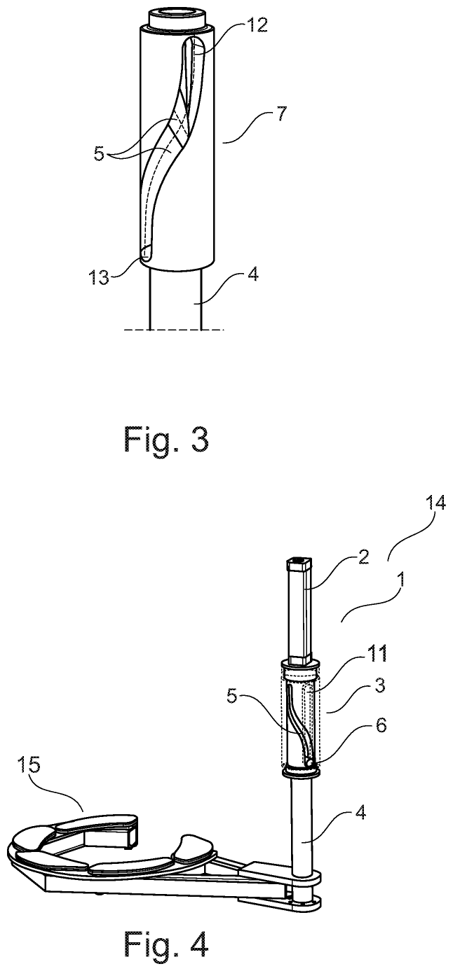

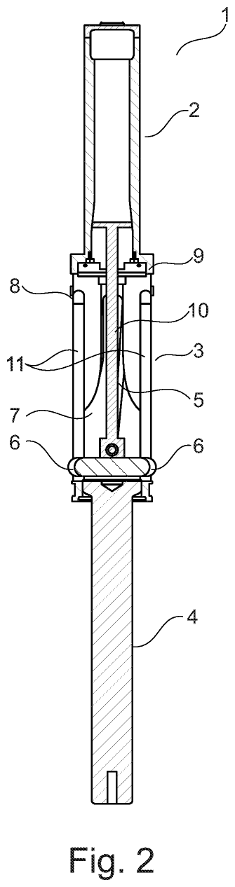

FIG. 2: A section through the slewing drive shown in FIG. 1,

FIG. 3: A perspective view of the guide body according to the embodiment shown in FIGS. 1 and 2,

FIG. 4: A perspective view of an embodiment of a loading and/or unloading device according to the invention, and

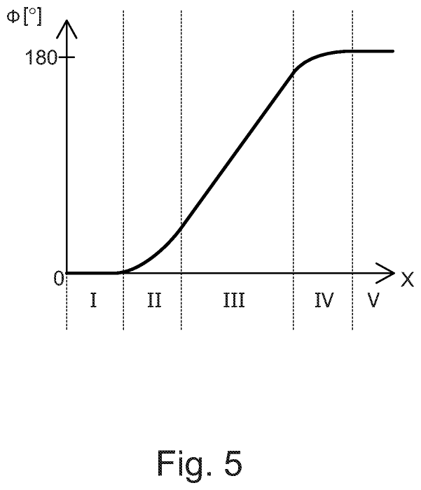

FIG. 5: A diagram in which the angle of rotation of the guide is plotted as a function of the position of the sliding element in the longitudinal direction for an embodiment of a slewing drive according to the invention.

FIG. 1 shows a side view of an embodiment of a slewing drive (1) according to the invention.

The slewing drive (1) has a linear drive (2), a converter (3) for converting the linear movement of the linear drive (1) into a rotary movement, and a rotatable axis (4).

In the embodiment of the invention shown, the linear axis of movement of the linear drive (1) is identical to the axis of rotation (XC) of the slewing drive (1).

The converter (3) has a guide (5) which is implemented as two slots in the guide body (7) arranged opposite each other and shaped like a helix or a spiral section. The guide body (7) is implemented as a hollow cylinder.

The drive element (10) of the linear drive (2), which is not visible in this illustration, runs in the cavity of the guide body (7). Two oppositely arranged sliding elements (6) projecting radially outward are connected to the drive element (10).

The sliding elements (6) engage both in the respective slot of the guide (5) and in a straight guide (11) in the housing (8) of the converter (3) straight guide (11), wherein the straight guide (11) is designed as two opposite grooves or slots in the housing (8) which are aligned parallel to the rotational axis (XC) of the slewing drive (1). The housing (8) is shown partially transparent in FIG. 1 so that the guide body (7) arranged therein is visible.

The guide body (7) is rotatably mounted in the housing (8) of the converter (3) by means of at least one pivot bearing (9) and is held in the direction of the linear axis of movement of the linear drive (2) so that, apart from any play that may be present and the rotational mobility about the axis of rotation (XC), the position of the guide body (7) is fixed.

Since the alignment of the sliding elements (6) is fixed by the guide in the straight guides (11), the guide body (7) is rotated when the drive element (10) and thus also the sliding elements (6) move, so that the guide (5) and the straight guide (11) lie on top of each other at the position of the sliding elements (6).

FIG. 2 shows a cross-section of the slewing drive (1) shown in FIG. 1. Here, the drive element (10) of the linear drive (2), which is mounted in the center of the guide body (7), can be seen.

FIG. 3 shows a perspective view of the guide body (7) according to the embodiment shown in FIGS. 1 and 2. The correspondingly shaped slots of the guide (5) arranged opposite each other in the guide body (7) can be seen.

At the lower end, the guide body (7) is connected to the rotatable axle (4).

In preferred embodiments of the invention, the guide body (7) and the rotatable axle (4) are designed as a single piece. For example, they are made from a single piece of steel.

It can also be seen that the diameter of the guide body (7) is larger than the diameter of the rotatable axle (4). This serves in particular to better secure the guide body (7) in the housing (8) of the converter (3), which engages under it to fix the guide body (7) in place.

At the upper end, the guide body (7) has an area with a reduced diameter. This serves to accommodate the guide body (7) in the pivot bearing (9).

The slots in the guide body (7) that form the guide (5) each run from a first end (12) to a second end (13). In the area of the ends (12, 13), the slots are linear and aligned parallel to the axis of rotation (XC).

FIG. 4 shows a perspective view of an embodiment of a loading and/or unloading device (14) according to the invention, comprising a slewing drive (1) according to the invention.

A receiving device (15) is connected to the rotatable axis (4) of the slewing drive (1), which in the embodiment shown is designed in a fork-like manner.

FIG. 5 shows a diagram in which, for an embodiment of a slewing drive (1) according to the invention, the angle of rotation Φ is plotted against the position X of the sliding element (6) in the longitudinal direction of the guide (5) or the straight guide (11).

The movement of the slewing drive (1) shown here has five ranges. Ranges I and V correspond to the end regions (12, 13) of the guide (5). In the embodiment of the invention shown, the end regions (12, 13) are linear and parallel to the axis of rotation (XC) and the linear guides (11), respectively, so that the linear movement of the sliding elements (6) in these regions is not accompanied by any rotation. The slope of the curve shown is therefore equal to 0 in these areas. With regard to the slewing drive (1), such areas without slope are holding positions.

In areas II and IV, the slope of the curve shown increases or decreases continuously. With a constant linear movement of the drive element (10) of the linear drive (2), this corresponds to an increase or decrease in the rotational speed of the slewing drive (1). Depending on the direction of movement of the linear drive (2), this is reversed accordingly.

In area III, the curve shown has a constant gradient. This is accompanied by a constant rotational speed of the slewing drive (1).

The use of transition areas II and IV before holding positions enables the slewing drive (1) to be operated without shock absorbers, because the rotational movement is stopped smoothly or gently.

In embodiments of the invention, more than two holding positions are also conceivable.

1-20. (canceled)

21. A slewing drive for a loading and/or unloading device, comprising: at least one linear drive; a converter for converting linear movement of the linear drive into a rotary movement; and at least one rotatable axle, wherein a linear axis of movement of the linear drive and an axis of rotation of the slewing drive are approximately parallel or identical.

22. The slewing drive according to claim 21, wherein the linear axis of movement of the linear drive is vertically aligned.

23. The slewing drive according to claim 21, wherein the converter includes at least one guide and at least one sliding element guided in the at least one guide.

24. The slewing drive according to claim 23, wherein the guide is spirally or helically shaped at least in some areas.

25. The slewing drive according to claim 23, wherein the guide is a groove or slot in or on a guide body.

26. The slewing drive according to claim 23, wherein the guide has a first end and a second end and extends in a direction of the axis of rotation of the slewing drive from the first end to the second end, wherein the guide has a linear region at least in a region of one of the ends.

27. The slewing drive according to claim 23, wherein the sliding element is a pin.

28. The slewing drive according to claim 23, wherein one of the elements guide or the sliding element is firmly connected to a drive element of the linear drive, wherein a respective other of the guide or the sliding element is mounted in a manner rotatable relative to the element firmly connected to the linear drive so as to be rotatable about the rotary axis of the slewing drive by linear movement of the drive element of the linear drive and by guidance of the sliding element in the guide.

29. The slewing drive according to claim 28, comprising at least one pivot bearing that rotatably supports the respective rotatable element.

30. The slewing drive according to claim 25, wherein the at least one guide includes two corresponding guides arranged opposite each other on or in the guide body, the at least one sliding element including a sliding element guided in each guide.

31. The slewing drive according to claim 28, comprising at least one linear guide that ensures linear movement of the at least one sliding element on a linear axis of movement.

32. The slewing drive according to claim 31, wherein the at least one sliding element engages both in the at least one guide and in the at least one linear guide, wherein either the linear guide or the guide is arranged in a fixed and immovable manner so that a rotation of the rotatable element provided with the respective other guide element is forcible.

33. A loading and/or unloading device, comprising: at least one slewing drive according to claim 21; and a receiving device connected to the rotatable axle of the slewing drive for receiving and/or holding an object to be loaded or unloaded.

34. A tire heating press, comprising at least one loading and/or unloading device according to claim 33.

35. A method for handling tires, comprising the steps of:
picking up a green tire or a vulcanized tire using a loading and/or unloading device;
swiveling into a tire heating press and depositing the green tire; or
swiveling out of a tire heating press and depositing the vulcanized tire, wherein the swiveling steps include using a loading and/or unloading device with a slewing drive according to claim 33.

36. The method for handling tires according to claim 35, including moving the linear drive of the slewing drive at a constant speed.

37. The method for handling tires according to claim 36, wherein linear movement of the drive element of the linear drive moves at least one sliding element through a guide so that a rotatable element is rotated about the axis of rotation of the slewing drive.

38. The method for handling tires according to claim 37, wherein a movement profile of the rotational movement is realized with at least one linear range in which no rotational movement takes place.

39. The method for handling tires according to claim 38, wherein a movement profile of the rotational movement is realized with at least four regions, each with assigned rotational speeds, wherein two regions represent end regions in which no rotational movement takes place, and two regions represent transition regions in which the speed of the rotational movement is uniformly increased and/or decreased.

40. The method for handling tires according to claim 39, wherein a movement profile of the rotational movement is realized with at least five ranges, each with assigned rotational speeds, wherein two ranges represent end ranges in which no rotational movement takes place, and two ranges represent transition ranges in which the speed of the rotational movement is uniformly increased and/or decreased, and one range has a constant rotational speed not equal to 0.
